(19) United States
(12) Patent Application Publication
(10) Pub. No.: US 2026/0339538 A1
(43) Pub. Date: Oct. 29, 2026

(54) MIGRATING CONTAINERS FROM A CLOUD ENVIRONMENT TO A LOCAL SYSTEM

(71) Applicant: Red Hat, Inc., Raleigh, NC (US)

(72) Inventors: Leigh Griffin, Waterford (IE); Paolo Antinori, Milan (IT); Andrea Cosentino, Milan (IT)

(73) Assignee: Red Hat, Inc., Raleigh, NC (US)

(21) Appl. No.: 19/190,651

(22) Filed: Apr. 27, 2025

(51) Int. Cl. G06F 3/06

(52) U.S. Cl. CPC G06F 3/0647; G06F 3/0604; G06F 3/067

(57) ABSTRACT

Containers can be migrated from a cloud environment to a local system. For example, a system can receive a first version of a container stored in a first cloud environment and a second version of the container stored in a second cloud environment. The first version may include a first set of container layers and the second version may include a second set of container layers. The system may determine a container layer of the first set of container layers that does not match a corresponding container layer of the second set of container layers. The system may then select the container layer or the corresponding container layer. Additionally, the system may generate a third set of container layers that includes the selected container layer and that includes container layers of the first set of container layers that match corresponding container layers in the second set of container layers.

### TECHNICAL FIELD

The present disclosure relates generally to container management. More specifically, but not by way of limitation, this disclosure relates to migrating containers from a cloud environment to a local system.

### BACKGROUND

Software services such as applications, serverless functions, and microservices can be deployed inside containers within a computing environment. A container is a relatively isolated virtual computing environment created by leveraging the resource isolation features (e.g., cgroups and namespaces) of the Linux Kernel. Deploying software services inside containers can help isolate the software services from one another, which can improve speed and security and provide other benefits.

Containers are deployed from image files using a container engine, such as Docker or Podman. These image files are often referred to as container images. A container image can be conceptualized as a stacked arrangement of layers in which a base layer is positioned at the bottom and other layers are positioned above the base layer. The other layers may include a target software service and its dependencies, such as its libraries, binaries, and configuration files. The target software service may be configured to run (e.g., on a guest operating system) within the isolated context of the container.

### BRIEF DESCRIPTION OF THE DRAWINGS

FIG. 1 is a block diagram of an example of a computing environment for migrating containers from a cloud environment to a local system according to some embodiments of the present disclosure.

FIG. 2 is a block diagram of another example of a computing environment for migrating containers from a cloud environment to a local system according to some embodiments of the present disclosure.

FIG. 3 is a flowchart of a method for migrating containers from a cloud environment to a local system according to some embodiments of the present disclosure.

### DETAILED DESCRIPTION

Cloud computing can enable flexibility in device and location with respect to accessing computing resources. But, using cloud environments can introduce security risks, for example when configuration management is controlled by multiple users. A misconfigured cloud environment with public write access can result in data loss or security breaches by malicious actors. So, it may be beneficial to store and execute containers and/or software applications in certain ways that improve security and privacy protections. Accordingly, users may implement reverse cloud migration or cloud repatriation to move away from using the cloud environments to instead use on-premise infrastructure. But, to avoid vendor lock-in caused by using a sole cloud provider, the users may have employed a hybrid cloud environment that uses infrastructure from multiple cloud providers. Migrating away from the hybrid cloud environment to improve privacy protections can be complicated by the need to merge different versions of containers being executed by the multiple cloud providers in the on-premise infrastructure. Otherwise, on-premise infrastructure may store a copy of each version of the container, leading to significant resource consumption.

Some examples of the present disclosure can overcome one or more of the issues mentioned above by migrating containers from cloud environments to a local system such that the containers are stored in an on-premise computing environment, such as a physical server. Using the on-premise computing environment can afford greater security protection compared to using a cloud environment, enabling a user to comply with privacy protections implemented according to a respective jurisdiction associated with a container. For example, the on-premise computing environment may have consolidated management or predefined security parameters to enable relatively higher data privacy protections. In addition, the on-premise computing environment can store container layers associated with each version of a container. So, rather than storing each version of a container, the footprint and resource consumption for versions of the container can be reduced using container layers.

Migrating a container from the cloud environments to the on-premise computing environment can involve a system receiving a first version of the container stored in a first cloud environment. The system can also receive a second version of the container stored in a second cloud environment. The system can compare a set of container layers associated with the first version to a set of container layers associated with the second version. In doing so, the system can identify container layers that are the same in both the first version and the second version of the container. Moreover, the system can identify container layers that are different in the first version than in the second version. For each of the container layers that are different, the system may determine a function of the container layer associated with first version and a function of a corresponding container layer associated with the second version. If the functions are the same or similar (e.g., if the container layers serve a same or similar purpose with respect to the container), the system may select one of the container layers. In contrast, in the functions are not the same (e.g., if a container layer of the first version serves a different purpose than a container layer in the second version), the container layer associated the first version may be labeled with the first cloud environment and the corresponding container layer associated with the second version may be labeled with the second cloud environment.

Thus, as a result of the comparison of layers, container layers which do not differ between the first version and the second version are identified and container layers that do differ between the first version and the second version are also identified. A singular version of the container representative of both the first version and the second version may then be generated. For example, a third set of container layers can be generated that has one copy of each of the container layers that were the same in both the first and second versions. The third set of container layers can further include one copy of each of the container layers that were not the same, but performed the same or similar functions (e.g., served the same or a similar purpose with respect to the container). Moreover, for the container layers that perform different functions, and therefore represent the differences between the first and second version of the container, the third set of container layers may include both of the container layers labeled with the respective environments. Moreover, a specification file associated with the singular version of the container may include logic (e.g., an if/else statement) indicative of when to implement different container layers.

The system may then store the singular version of the container (e.g., including the third set of container layers and the specification file) in a physical server. The singular version of the container can be usable by the system to execute the first version and the second version of the container (e.g., based on the logic in the specification file). As such, the first and second versions of the container are moved on-premise using a smaller resource footprint than the cloud environments and in a manner that allows any of the versions of the container from the cloud environments to be executed by enabling the corresponding container layers for the versions in one container. Once the container versions are migrated to the on-premise computing environment, the versions stored in the cloud environments may be removed to conserve computing resources, such as memory space.

In one particular example, a computing device, such as a physical server, coupled to two cloud environments—cloud environment A and cloud environment B can receive version A of a container that is run cloud environment A. In addition, the physical server can receive version B of the container that runs in the cloud environment B. The physical server may then compare container layers of version A to container layers of version B and generate a third set of layers based on the comparison.

For instance, the physical server can compare identifiers of each container layer of version A and to identifiers of each container layer of version B may. In particular, each container layer of version A can be compared to a container layer of version B that is at a same position of a stack of the layers in version A and version B respectively. There may be two container layers of version A being compared to two container layers of version B. An identifier of a first container layer (e.g., a lowest container layer) of version A can be compared to an identifier of a first container layer (e.g., a lowest container layer) of version B. The identifiers may be identical to one another.

Next, an identifier of a second container layer (e.g., a next layer stacked on top of the first container layer) of version A can be compared to an identifier of a second container layer (e.g., a next layer stacked on top of the first container layer) of version B. The identifiers may be different from one another. Due to the identifier of the second container layer of version A being different from the identifier of the second container layer of version B, the physical server may determine whether the respective second layers are compatible (e.g., whether the respective second layers perform the same functions with respect to the different versions of the container). For instance, version A may be version 1.1.1 of the container and version B may be version 2.1.1 of the container. There may be predefined rules indicative of which container versions include compatible layers. Based on the predefined rules and that version A and B are different major versions of the container, the physical server may determine that the second container layers are not compatible. As a result, the physical server may append the second container layer of version A to include a label indicative of the second environment and append the second container layer of version B to include a label indicative of the second cloud environment.

The physical server may then generate a singular version of the container representative of both version A and version B. To do so, the physical server may generate a third set of container layers representative of both version A and version B. Thus, the third set of container layers can include either the first container layer of version A or the first container layer of version B due to the first container layers of versions A and B having the same identifier. Moreover, the third set of container layers can include the appended second layer of container A and the appended second layer of container B. Moreover, a specification file associated with the singular version of the container may include logic (e.g., an if/else statement) indicative of when to implement the appended second layer of container A and when to implement the second layer of container B. The system may then store the singular version of the container (e.g., including the third set of container layers and the specification file) in a physical server.

The singular version of the container can be usable by the system to execute version A and version B (e.g., based on the logic in the specification file). For instance, the physical server may deploy and execute version A by deploying the singular version of the container with a label indicative of the first cloud environment. As a result, during execution of the container, the logic in the specification is followed such that the appended second container layer of container A is implemented (e.g., is enabled) while the appended second container layer of container B is not implemented (e.g., is disabled).

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

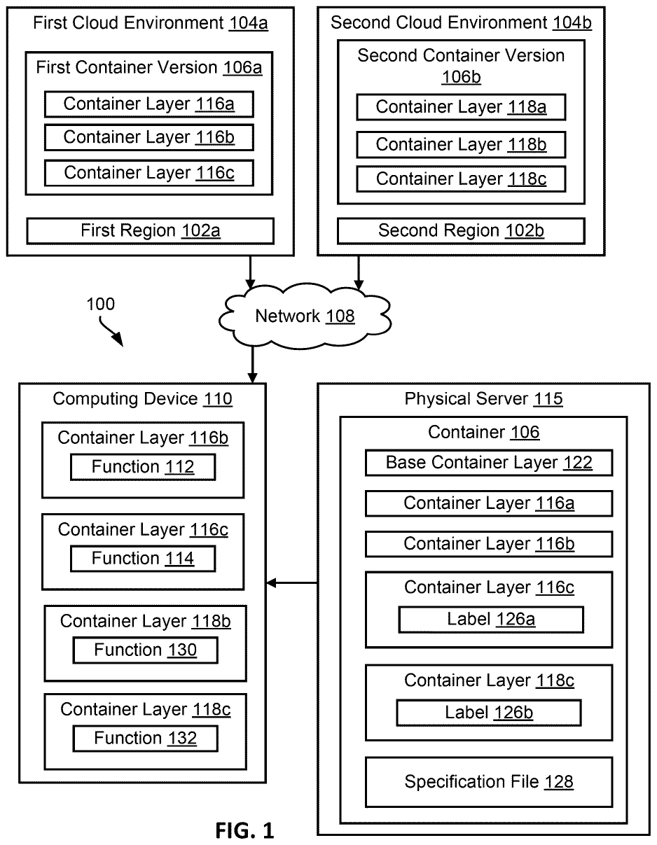

FIG. 1 is a block diagram of an example of a computing environment 100 for migrating containers from a cloud environment 104 to a local system according to one example of the present disclosure. The local system can be an on-premise computing system with a physical server 115 to store software components (e.g., container layers, specification files, or the like) related to a container 106. Components within the computing environment 100 may be communicatively coupled via a network 108, such as a local area network (LAN), wide area network (WAN), the Internet, or any combination thereof. For example, the computing environment 100 can include a computing device 110 communicatively coupled to a first cloud environment 104a and a second cloud environment 104b through the network 108. The first cloud environment 104a may be provided by a different entity (e.g., cloud provider) than the second cloud environment 104b. Or, the first cloud environment 104a and the second cloud environment 104b may be provided by the same entity, but may differ in that the first cloud environment 104a may be associated with a different geological region than the second cloud environment 104b. For example, the first cloud environment 104a may be associated with a first region 102a (e.g., European west) while the second cloud environment 104b may be associated with a second region 102b (e.g., European center).

The computing device 110 can also be communicatively coupled to the physical server 115, enabling the computing device 110 to migrate the container 106 from the cloud environments 104a-b to the physical server 115. In some examples, the computing device 110 may be the physical server 115. Additionally, or alternatively, the computing device 110 may communicate with a different physical server using the network 108 to migrate the container 106. Examples of cloud providers that host the cloud environments 104a-b can include Amazon Web Services (AWS), Microsoft Azure, International Business Machines Corporation (IBM), and Google Cloud Platform (GCP). Each cloud environment can include a respective version of the container 106. For example, the first cloud environment 104a can be associated with a first container version 106a and the second cloud environment 104b can be associated with a second container version 106b. The first container version 106a and the second container version 106b are different versions of the same container 106.

In general, for each container running in the cloud environments 104a-b, the computing device 110 can receive each version of the container from each of the cloud environments 104a-b. In receiving the container versions 106a-b, the computing device 110 may receive specification files for each of the container version 106a-b. The computing device 110 may further label each specification file based on region, entity, or a combination thereof of the corresponding cloud environment. For example, a first specification file associated with the first container version 106a may be labeled with “AWS-European-West” while a second specification file associated with the second container version 106b may be labeled with “Azure-European-West.”

The specification files may outline (e.g., describe and/or define) container layers of each of the container versions 106a-b. A container layer may be a read-only file system layer that represents a change to a container image. The container image may be an immutable software package that includes everything needed to deploy and run a container. The container layers may be stacked on top of a base container layer to form the container image. As such, the first container version 106a may include a first set of container layers 116a-c that may be conceptually stacked on top of a base container layer (not shown). Additionally, the second container version 106b may include a second set of container layers 118a-c that may be conceptually stacked on top of the base container image (not shown). The first specification file can therefore outline the first set of container layers 116a-c and the second specification can outline the second set of container layers 118a-c.

In some examples, each container layer may include a unique identifier and a filesystem stored as a compressed archive. The computing device 110 may parse each specification file to obtain the unique identifier for each of the first set of container layers 116a-c and the second set of container layers 118a-c. The computing device 110 may then compare the unique identifiers to determine whether each layer in the first set of container layers 116a-c matches (e.g., has a same unique identifier as) a corresponding layer in the second set of container layers 118a-c. For example, a first container layer 116a of the first set of container layer 116a-c may correspond to a first container layer 118a of the second set of container layers 118a-c. As mentioned above, the sets of container layers 116a-c, 118a-c may be conceptually stacked. Thus, the sets of container layers 116a-c, 118a-c may be arranged in a specific order. For example, a second container layer 116b may be stacked on top of (organized above) the first container layer 116a and a third container layer 116c may be stacked on top of the second container layer 116b. Similarly, a second container layer 118b may be stacked on top of (organized above) the first container layer 118a and a third container layer 118c may be stacked on top of the second container layer 118b. Accordingly, the first container layers 116a, 118a may correspond in that they are both organized at a same level with respect the respective sets of container layers 116a-c, 118a-c. Similarly, the second container layers 116b, 118b may correspond and the third container layers 116c, 118c may correspond.

In contrast to the above, in some examples, the computing device 110 may compare content of the container layers rather than the unique identifiers. For example, if technology differs between the first cloud environment 104a and the second cloud environment 104b, the unique identifiers may not be comparable. The technology may differ is that the container 106 may be deployed using different hardware or virtualization solutions (e.g., different server types, using different storage solutions, using specialized processors, etc.) at each of the cloud environments 104a-b.

In examples in which the technology differs between the cloud environments 104a-b, the computing device 110 may access the content of each of the first set of container layers 116a-c and the content of each of the second set of container layers 118a-c. The content of the container layers may be the files stored as a compressed archive. Thus, comparing the content of each of the first set of container layers 116a-c to content of corresponding container layers in the second set of container layers 118a-c may involve comparing files in each container layer to each corresponding container layer, analyzing which files were added, modified, or deleted for each container layer in comparison to the corresponding container layer, or a combination therefore. Comparing files may involve comparing file characteristics (e.g., a file name, file path, time stamp, size, or the like) of files in the compressed archive of a container layer to characteristics of files in the compressed archive of another, corresponding container layer.

By comparing the unique identifiers or the content (e.g., file characteristics) of the container layers in the first set of container layers 116a-c to the unique identifiers or the content of the second set of container layers 118a-c, the computing device 110 can identify container layers in the first set of container layers 116a-c that are different from corresponding container layers in the second set of container layers 118a-c. For example, the first container layer 116a of the first container version 106a may have a same unique identifier and/or content as the first container layer 118a of the second container version 106b. However, the second container layer 116b and the third container layer 116c may have a different unique identifier and/or different contents from the second container layer 118b and the third container layer 118c respectively. Therefore, the computing device 110 may determine that the first container layer 116a matches the corresponding container layer (e.g., the first container layer 118a), that the second container layer 116b does not match the corresponding container layer (e.g., the second container layer 118b), and that the third container layer 116c does not match the corresponding container layer (e.g., the third container layer 118c).

In response to determining that the second and third container layers 116b, 116c of the first container version 106a do not match the corresponding second and third container layers 118b,118c of the second container version 106b, the computing device 110 may determine whether functions associated with second and third container layers 116b, 116c match functions associated with second and third container layers 118b, 118c. The function of a container layer may relate to a purpose of the container layer in the container. For example, a function of a container layer may be to carry and implement software application code, software application configuration settings, or the like. In another example, a function of a container layer may be to set an environment variable (e.g., by setting up a debugging mode, a testing environment, staging environment, or a production environment) inside a container.

The computing device 110 may determine whether the functions of the second and third container layers 116b, 116c match the functions of the second and third container layers 118b, 118c using a testing environment. For example, the computing device 110 may deploy the first container version 106a in the testing environment to observe a function 112 of the second container layer 116b. The computing device 110 may also deploy the second container version 106b in the testing environment to observe a function 130 of the second container layer 118b. The computing device 110 may observe the functions 112, 130 of each of second container layers 116b, 118b respectively by analyzing an impact of each of the second container layers 116b, 118b on the behavior of the container 106 in the testing environment.

The computing device 110 may then compare the functions 112,130. As a result, the computing device may determine that both of the second container layers 116b, 118b of the first set of container layers 116a-c and the second set of container layers 118a-c respectively behave similarly (e.g., that function 112 and function 130 are the same or similar). For example, the application code, configuration settings, environment variables, or other function implemented by the second container layers 116b, 118b may be the same or similar. Moreover, the functions 112, 130 may be the same or similar even though a unique identifier or one or more file characteristics (e.g., a time stamp, file name, etc.) of the second container layers 116b, 118b are different.

In another example, the computing device 110 may determine whether the functions of the second and third container layers 116b, 116c match the functions of the second and third container layers 118b, 118c using a predefined set of rules. The predefined rules may, in some examples, indicate which container versions include compatible layers. For example, each container version 106a-b may include metadata indicative which major version, minor version, and micro version of the container 106 each container version 106a-b is. The predefined rules may then indicate which major versions, minor versions, micro versions, or combinations thereof are compatible and which are not compatible. Versions that are compatible may have container layers that perform the same or similar functions despite differences in unique identifiers or content.

Upon determining that the functions of the second container layers 116b, 118b match, the computing device may select one of the second container layers 116b,118b, to use in generating a local version of the container. For example, as shown in FIG. 1, the second container layer 116b is selected for the generating the local version of the container 106. As such, the second container layer 116b is shown as being stored in the physical server 115. Similarly, because the first container layers 116a, 118a are the same, only the first container layer 116a may be selected for the generating the local version of the container and stored in the physical server 115.

However, in some examples, functions of corresponding layers of different container versions may not match. In an example, using the testing environment or the predefined rules, the computing device 110 may determine that a function 114 of the third container layer 116c of the first container version 106a does not match (e.g., is different from) a function 132 of the third container layer 118c of the second container version 106b. For example, when the first container version 106a is deployed in the testing environment, the function 114 of the third container layer 116c may be to respond to a user request in a first language (e.g., English). In contrast, when the second container version 106b is deployed in the testing environment, the function 132 of the third container layer 118c may be to respond to a user request in a second language (e.g., Italian).

In response to determining that the function 114 of the third container layer 116c of the first container version 106a does not match the function 132 of the third container layer 118c of the second container version 106b, the computing device 110 may append the third container layer 116c to include a first label 126a indicative of the first cloud environment 104a. Additionally, the computing device 110 may append the third container layer 118c to include a second label 126b indicative of the second cloud environment 104b. Additionally or alternatively, the computing device 110 may append the third container layer 116c to include a label indicative of the first region 102a and may append the third container layer 118c to include a label indicative of the second region 102b.

The computing device 110 may then include the third container layer 116c with the first label 126a and the third container layer 118c with the second label 126b when generating the local version of the container. In doing so, the computing device 110 may then generate the local version of the container 106 that is representative of both the first container version 106a and the second container version 106b. As shown in FIG. 1, the local version of the container 106 stored on the physical server 115 includes the third container layer 116c with the first label 126a and the third container layer 118c with the second label 126b.

The local version of the container 106 can be usable by the computing device 110 to execute either of the container versions 106a-b of the container 106. For example, the local version of the container may be deployed with a label indicating that the which of the third container layers 116c, 118c should be implemented. Additionally or alternatively, the computing device 110 may generate a specification file 128 associated with the local version of the container 106 that includes configuration data for the container 106, and information related to each of the layers selected for the local version of the container 106 (e.g., the first container layer 116a, the second container layer 116b, the third container layer 116c, and the third container layer 118c). Moreover, the specification file 128 may be generated to include logic (e.g., an if/else statement) indicative of when to implement the third container layer 116c and when to implement the third container layer 118c. The logic in the specification file 128 may indicate which of the third container layers 116c, 118c to implement based on a time of deployment of the container 106, a location of a node on which the container 106 is deployed, or other information. Additionally or alternatively, the logic in the specification file may indicate which of the third container layers 116c, 118c to implement based on a time of a user request associated with the container 106, a location of a device from which the user request is received, or other information associated with the user request.

Thus, the computing device 110 can execute either container version 106a-b using the local version of the container 106 (e.g., using the base container layer 122, the first container layer 116a, the second container layer 116b, either the third container layer 116c or the third container layer 118c, and the specification file 128). Which container version is executed may be based on the logic in the specification file 128 and/or a label with which the local version of the container 106 is deployed. In one example, the computing device 110 may execute the first container version 106a using the local version of the container 106 (e.g., including the base container layer 122, the first container layer 116a, and the second container layer 116b) with the third container layer 116c with the first label 126a enabled and with the third container layer 118c with the second label 126b disabled. In contrast, in another example, the computing device 110 may execute the second container version 106b using the local version of the container 106 (e.g., including the base container layer 122, the first container layer 116a, the second container layer 116b) with the third container layer 118c with the second label 126b enabled and with the third container layer 116c with the first label 126a disabled.

While FIG. 1 depicts a specific arrangement of components, other examples can include more components, fewer components, different components, or a different arrangement of the components shown in FIG. 1. For instance, while FIG. 1 shows two container versions associated with two cloud environments, any number of versions associated with any number of cloud environments may be migrated to a local system in other examples. Moreover, while FIG. 1 is specific to generating container layers that correspond to different versions of a container, virtual machines may be used instead. For example, each difference between the version similarities and the different container versions can be implemented as a different storage layer that can be mounted on top of a virtual machine, similarly providing the mirroring of container versions outside of the cloud environment. Additionally, any component or combination of components depicted in FIG. 1 can be used to implement the process(es) described herein. For instance, the computing device 110 and the physical server 115 may be the same device that generates and stores the container layers for the different versions of a software application.

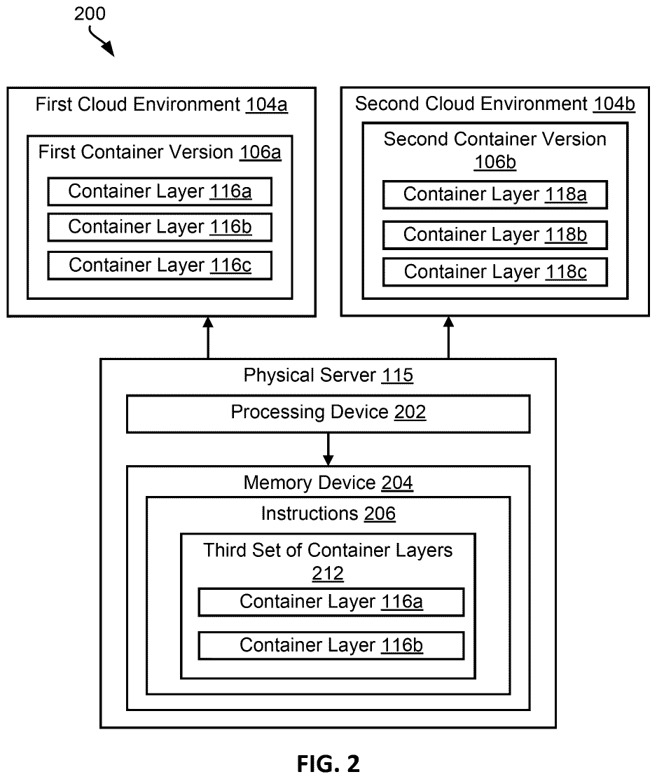

FIG. 2 is a block diagram of another example of a computing environment 200 for migrating containers from a cloud environment 104 to a local system according to one example of the present disclosure. The computing environment 200 can include a physical server 115 containing a processing device 202 communicatively coupled to a memory device 204. The physical server 115 can be communicatively coupled to the cloud environment 104 to migrate the container 106 from the cloud environment 104 to the physical server 115. Migrating the container 106 to a local system can involve removing the container 106 from the cloud environment 104 once the container 106 is stored in the physical server 115.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code. Non-limiting examples of a computer-readable medium include magnetic disk(s), memory chip(s), ROM, random-access memory (RAM), an ASIC, a configured processor, and optical storage.

In some examples, the processing device 202 can execute the instructions 206 to perform operations. For example, the processing device 202 can receive a first version of the container 106 (e.g., first container version 106a) stored in a first cloud environment 104a and a second version of the container 106 (e.g., second container version 106b) stored in a second cloud environment 104b. The first version of the container may include a first set of container layers 116a-c and the second version of the container may include a second set of container layers 118a-c. The processing device 202 may further determine a container layer (e.g., second container layer 116b) of the first set of container layers 116a-c that does not match a corresponding container layer (e.g., second container layer 118b) of the second set of container layers 118a-c. In response to determining that the container layer in the first set of container layers 116a-c does not match the corresponding container layer in the second set of container layers 118a-c, the processing device 202 may select one of the container layer and the corresponding container layer (e.g., one of the second container layer 116b and the second container layer 118b). Additionally, the processing device 202 may generate a third set of container layers 212 comprising the selected one of the container layer and the corresponding container layer (e.g., second container layer 116b) and comprising one or more container layers in the first set of container layers 116a-c that match corresponding container layers in the second set of container layers 118a-c (e.g., first container layer 116a, which matches first container layer 118a). The processing device 202 may then store the third set of container layers 212 in the physical server 115. The third set of container layers 212 may be usable to execute the container 106.

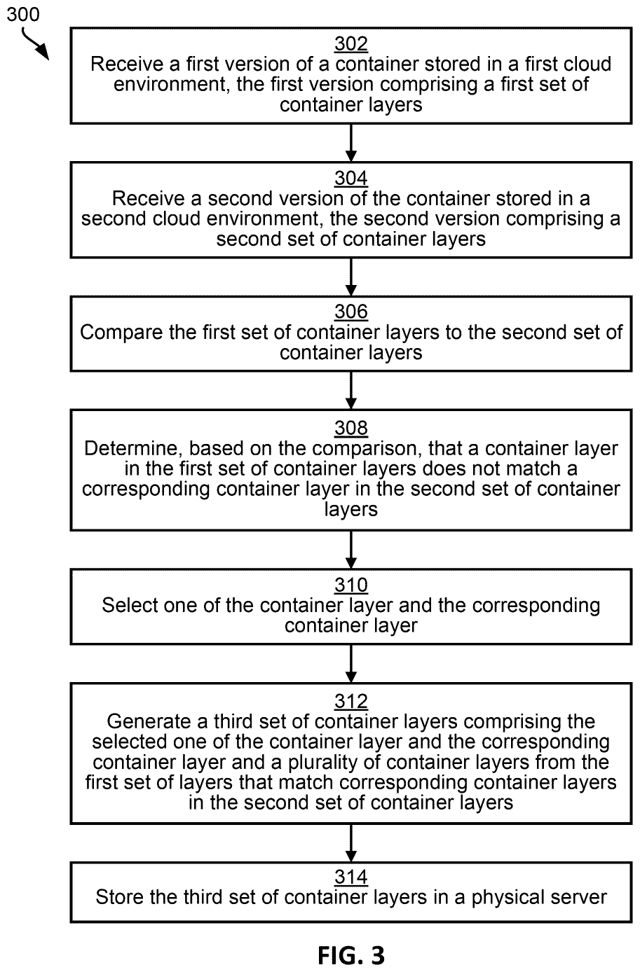

FIG. 3 is a flowchart of a method 300 for migrating containers from a cloud environment 104 to a local system according to one example of the present disclosure. The local system can be an on-premise computing system with a physical server 115 to store the container. In some examples, the processing device 202 can perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

At block 302, the processing device 202 receives a first version of a container stored in a first cloud environment 104a. The first version of the container (e.g., first container version 106a) may include a first set of container layers 116a-c. The first set of container layers 116a-c may include a base container layer (not shown) and one or more additional container layers (e.g., container layers 116a-c) that are conceptually stacked on top of the base container layer to form a container image.

At block 304, the processing device 202 receives a second version of the container stored in a second cloud environment 104b. The second version of the container (e.g., second container version 106b) may include a second set of container layers 118a-c. The second set of container layers 118a-c may include the base container layer (not shown) and one or more additional container layers (e.g., container layers 118a-c) that are conceptually stacked on top of the base container layer to form another container image.

The first cloud environment 104a may be provided by a different entity (e.g., cloud provider) than the second cloud environment 104b. Examples of cloud providers that may host the cloud environments 104a-b include Amazon Web Services (AWS), Microsoft Azure, International Business Machines Corporation (IBM), and Google Cloud Platform (GCP). Alternatively, the first cloud environment 104a and the second cloud environment 104b may be provided by the same entity, but may differ in that the first cloud environment 104a may be associated with a different geological region than the second cloud environment 104b. For example, the first cloud environment 104a may be associated with a first region 102a (e.g., European west) while the second cloud environment 104b may be associated with a second region 102b (e.g., European center).

At block 306, the processing device 202 compares the first set of container layers to the second set of container layers. The processing device 202 may specifically compare each container layer in the first set of container layers 116a-c to a corresponding container layer in the second set of container layers 118a-c. For example, for the first set of container layers 116a-c, a second container layer 116b may be stacked on top of (organized above) the first container layer 116a and a third container layer 116c may be stacked on top of the second container layer 116b. Similarly, for the second set of container layers 118a-c, a second container layer 118b may be stacked on top of (organized above) the first container layer 118a and a third container layer 118c may be stacked on top of the second container layer 118b. Accordingly, the first container layers 116a, 118a may correspond in that they are both organized at a same level with respect the respective sets of container layers 116a-c, 118a-c. Similarly, the second container layers 116b, 118b may correspond and the third container layers 116c, 118c may correspond.

At block 308, the processing device 202 determines, based on the comparison, that a container layer in the first set of container layers does not match a corresponding container layer in the second set of container layers. For example, the processing device 202 may access the content of the first set of container layers 116a-c and the content of the second set of container layers 118a-c. The content of the container layers may be files stored as a compressed archive. Thus, comparing the content of the first set of container layers 116a-c to content of the second set of container layers 118a-c may involve comparing files in each container layer and to file in each corresponding container layer, analyzing which files were added, modified, or deleted for each container layer in comparison to the corresponding container layer, or other information related to the files. Comparing files may include comparing characteristics (e.g., a file name, file path, time stamp, size, or the like) of each file in the compressed archive of a container layer may to characteristics of each file in the compressed archive of a corresponding container layer. Based on the comparison of the content of each of the first set of container layers 116a-c to the content of the corresponding layers in the second set of container layers 118a-c, the processing device may determine that second container layer 116b of the first container version 106a differs from its corresponding, second container layer 118b of the second container version 106b.

At block 310, the processing device 202 selects one of the container layer and the corresponding container layer. For example, in response to determining that the second container layer 116b of the first container version 106a does not match the corresponding second container layer 118b of the second container version 106b, the computing device 110 may determine whether a function 112 associated with second container layer 116b matches a function 130 associated with second container layers 118b. The function of a container layer may relate to a purpose of the layer in the container. For example, by deploying the first container version 106a in a testing environment, the processing device 202 may determine that the function 112 of the second container layer 116b is to carry and implement software application code. Moreover, by deploying the second container version 106b in the testing environment, the processing device 202 may determine that the function 130 of the second container layer 118b is also to carry and implement the software application code. Due to the functions 112, 130 of the second container layers 116b, 118b matching, the processing device may select one of the second container layer 116b and the corresponding second container layer 118b. In an example, the processing device 202 selects the second container layer 118b.

At block 312, the processing device 202 generates a third set of container layers. The third set of container layers may include the selected one of the container layer and the corresponding container layer (e.g., may include second container layer 118b). The third set of container layers may further include container layers from the first set of container layers 116a-c that match corresponding container layers in the second set of container layers 118a-c. For example, the first container layer 116a of the first container version 106a may match the first container layer 118a of the second container version 106b. Thus, the third set of containers may include the first container layer 116a.

At block 314, the processing device 202 stored the third set of container layers in a physical server 115. The third set of container layers may be used to execute the container 106. Moreover, after storing the third set of container layers in the physical server 115, the processing device 202 may remove the container versions 106a-b from the cloud environments 104a-b. Accordingly, processing device 202 moves the container 106 to an on-premise computing system that includes the physical server 115.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving a first version of a container stored in a first cloud environment and a second version of the container stored in a second cloud environment, the first version of the container comprising a first set of container layers, and the second version of the container comprising a second set of container layers;
determining a container layer of the first set of container layers that does not match a corresponding container layer of the second set of container layers;
in response to determining that the container layer in the first set of container layers does not match the corresponding container layer in the second set of container layers, selecting one of the container layer and the corresponding container layer;
generating a third set of container layers comprising the selected one of the container layer and the corresponding container layer and comprising a plurality of container layers in the first set of container layers that match corresponding container layers in the second set of container layers; and
storing the third set of container layers in a physical server, the third set of container layers usable to execute the container.

2. The system of claim 1, wherein the operations further comprise:
determining that a first function associated with the container layer matches a second function associated with the corresponding container layer; and
wherein the selecting the one of the container layer and the corresponding container layer is performed in response to determining that the first function matches the second function.

3. The system of claim 1, wherein the operations further comprise:
determining an additional container layer of the first set of container layers that does not match an additional corresponding container layer in the second set of container layers; and
determining that a first function associated with the additional container layer does not match a second function associated with the additional corresponding container layer.

4. The system of claim 3, wherein the operations further comprise, based on determining that the first function does not match the second function:
appending the additional container layer to include a label indicative of the first cloud environment; and
appending the additional corresponding container layer to include a label indicative of the second cloud environment.

5. The system of claim 4, wherein the third set of container layers further comprises the additional container layer with the label indicative of the first cloud environment and the additional corresponding container layer with the label indicative of the second cloud environment.

6. The system of claim 5, wherein the operations further comprise:
executing the first version of the container using the third set of container layers with the additional container layer enabled and the additional corresponding container layer disabled; or
executing the second version of the container using the third set of container layers with the additional corresponding container layer enabled and the additional container layer disabled.

7. The system of claim 1, wherein the first cloud environment is provided by a different entity than the second cloud environment, or wherein the first cloud environment is provided by a same entity as the second cloud environment and the first cloud environment is associated with a different geological region than the second cloud environment.

8. A computer-implemented method comprising:
receiving a first version of a container stored in a first cloud environment and a second version of the container stored in a second cloud environment, the first version of the container comprising a first set of container layers, and the second version of the container comprising a second set of container layers;
determining a container layer of the first set of container layers that does not match a corresponding container layer of the second set of container layers;
in response to determining that the container layer in the first set of container layers does not match the corresponding container layer in the second set of container layers, selecting one of the container layer and the corresponding container layer;
generating a third set of container layers comprising the selected one of the container layer and the corresponding container layer and comprising a plurality of container layers in the first set of container layers that match corresponding container layers in the second set of container layers; and
storing the third set of container layers in a physical server, the third set of container layers usable to execute the container.

9. The computer-implemented method of claim 8, further comprising:
determining that a first function associated with the container layer matches a second function associated with the corresponding container layer; and
wherein the selecting the one of the container layer and the corresponding container layer is performed in response to determining that the first function matches the second function.

10. The computer-implemented method of claim 8, further comprising:
determining an additional container layer of the first set of container layers that does not match an additional corresponding container layer in the second set of container layers; and
determining that a first function associated with the additional container layer does not match a second function associated with the additional corresponding container layer.

11. The computer-implemented method of claim 10, further comprising, based on determining that the first function does not match the second function:
appending the additional container layer to include a label indicative of the first cloud environment; and
appending the additional corresponding container layer to include a label indicative of the second cloud environment.

12. The computer-implemented method of claim 11, wherein the third set of container layers further comprises the additional container layer with the label indicative of the first cloud environment and the additional corresponding container layer with the label indicative of the second cloud environment.

13. The computer-implemented method of claim 12, further comprising:
executing the first version of the container using the third set of container layers with the additional container layer enabled and the additional corresponding container layer disabled; or
executing the second version of the container using the third set of container layers with the additional corresponding container layer enabled and the additional container layer disabled.

14. The computer-implemented method of claim 8, wherein the first cloud environment is provided by a different entity than the second cloud environment, or wherein the first cloud environment is provided by a same entity as the second cloud environment and the first cloud environment is associated with a different geological region than the second cloud environment.

15. A non-transitory computer-readable medium comprising program code executable by a processing device for causing the processing device to perform operations comprising:
receiving a first version of a container stored in a first cloud environment and a second version of the container stored in a second cloud environment, the first version of the container comprising a first set of container layers, and the second version of the container comprising a second set of container layers;
determining a container layer of the first set of container layers that does not match a corresponding container layer of the second set of container layers;
in response to determining that the container layer in the first set of container layers does not match the corresponding container layer in the second set of container layers, selecting one of the container layer and the corresponding container layer;
generating a third set of container layers comprising the selected one of the container layer and the corresponding container layer and comprising a plurality of container layers in the first set of container layers that match corresponding container layers in the second set of container layers; and
storing the third set of container layers in a physical server, the third set of container layers usable to execute the container.

16. The non-transitory computer-readable medium of claim 15, wherein the operations further comprise:
determining that a first function associated with the container layer matches a second function associated with the corresponding container layer; and
wherein the selecting the one of the container layer and the corresponding container layer is performed in response to determining that the first function matches the second function.

17. The non-transitory computer-readable medium of claim 15, wherein the operations further comprise:
determining an additional container layer of the first set of container layers that does not match an additional corresponding container layer in the second set of container layers; and
determining that a first function associated with the additional container layer does not match a second function associated with the additional corresponding container layer.

18. The non-transitory computer-readable medium of claim 17, wherein the operations further comprise, based on determining that the first function does not match the second function:
appending the additional container layer to include a label indicative of the first cloud environment; and
appending the additional corresponding container layer to include a label indicative of the second cloud environment.

19. The non-transitory computer-readable medium of claim 18, wherein the third set of container layers further comprises the additional container layer with the label indicative of the first cloud environment and the additional corresponding container layer with the label indicative of the second cloud environment.

20. The non-transitory computer-readable medium of claim 19, wherein the operations further comprise:
executing the first version of the container using the third set of container layers with the additional container layer enabled and the additional corresponding container layer disabled; or
executing the second version of the container using the third set of container layers with the additional corresponding container layer enabled and the additional container layer disabled.
